(19) United States
(12) Patent Application Publication
(10) Pub. No.: US 2024/0246570 A1
(43) Pub. Date: Jul. 25, 2024

(54) PATH PLANNING SYSTEM AND PATH PLANNING METHOD THEREOF

(71) Applicant: National Yang Ming Chiao Tung University, Hsinchu (TW)

(72) Inventors: Jiun-In GUO, Hsinchu (TW); Zheng-Yi XUE, Hsinchu (TW)

(21) Appl. No.: 18/196,245

(22) Filed: May 11, 2023

(30) Foreign Application Priority Data
Jan. 23, 2023 (TW) 112102888

(51) Int. Cl. B60W 60/00; B60W 30/08; B60W 30/12; B60W 30/18; B60W 40/06; G01S 17/86; G01S 17/89; G01S 17/931; G06V 10/762; G06V 10/84; G06V 20/56; G06V 20/58

(52) U.S. Cl. CPC B60W 60/0016; B60W 30/08; B60W 30/12; B60W 30/18163; B60W 40/06; G01S 17/86; G01S 17/89; G01S 17/931; G06V 10/762; G06V 10/84; G06V 20/58; G06V 20/588; B60W 2420/42; B60W 2420/52; B60W 2552/00; B60W 2554/00

(57) ABSTRACT

The path planning system projects a plurality of path distance point clouds to a path image to generate a path and distance point composition image, and then input the path and distance point composition image to a deep learning model and a probabilistic graphical model to obtain a path segmentation image. The path planning system obtains an adjacent lane point cloud and a main lane point cloud. The path planning system clusters the adjacent lane point cloud and the main lane point cloud, calculates an adjacent lane cluster center and a main lane cluster center, and transforms a LIDAR coordinates of the adjacent lane cluster center and the main lane cluster center to a car coordinate. The path planning system obtains a changing path and a main path by smoothing the car coordinate, and selects the changing path or the main path as a driving path according to obstacle information.

### CROSS REFERENCE TO RELATED APPLICATION

This application claims the benefit of Taiwan Patent Application Serial No. 112102888 filed on Jan. 23, 2023. The entirety of each Application is incorporated herein by reference.

### BACKGROUND OF THE INVENTION

### 1. Field of the Invention

The present invention relates to a path planning system for real-time lane change without a high-precision vector map.

### 2. Description of Related Art

Traffic safety has always been a very important issue. With the development of autonomous driving technology, driver assistance systems have become an indispensable technology. Providing driver warnings can not only protect driving safety but also improve driving quality. However, early driver assistance system algorithms were limited to many feature rules, which could lead to system failure in complex environments. In addition, in the past, when executing lane changes, many self-driving car software programs used high-precision vector maps to determine the accurate positions of surrounding lanes in order to reduce computational complexity and simplify path planning, and used this information to complete lane changing path planning.

For example, Autoware is a self-driving open-source architecture proposed by Shinpei Kato's team at Nagoya University in Japan, which has been used in both research and commercial applications. This architecture uses high-precision vector maps that include traffic information such as lane lines, traffic lights, and intersections. Using vector information, it obtains the path of road in the intersection area. In addition, Apollo is a self-driving car software proposed by Chinese internet company Baidu, similar to the design of Autoware. Apollo also uses high-precision vector maps, and the vector map format it adopts is the OpenDrive format.

However, the cost of building high-precision vector maps is very high. The marking of high-precision vector maps requires a lot of manpower and the construction of complex marking software. In addition, it requires cooperation from government departments to obtain the necessary data. Furthermore, the vector map formats in various regions are not yet completely unified, making marking even more difficult. When the information in the high-precision vector map does not match the actual field where the vehicle is located, the driver assistance system cannot correctly identify the surrounding lane environment of the car, which may result in path planning errors and lead to driving hazards.

Accordingly, how to provide a path planning system that does not require the use of high-precision vector maps and can plan driving paths in real-time is a pressing technical challenge that needs to be addressed in the industry.

### SUMMARY OF THE INVENTION

An objective of the present disclosure is to provide a path planning mechanism that uses a camera and a LIDAR scanner to generate images, and based on a deep learning model and a probabilistic graph model to analyze the images and segment the roads to identify lane lines, drivable areas, and adjacent lane areas. The deep learning model integrates lane line segmentation and detection, which greatly reduces computational complexity. With only one camera and one LIDAR scanner, the path planning system can plan the vehicle's current driving path in real-time without the need for a high-precision vector map, thus saving the cost of building the high-precision vector map.

Furthermore, the connected domains are further calculated to determine whether to change lanes and achieve real-time path planning. In this way, the present invention can reduce the dependence of autonomous vehicles on high-precision vector maps, and only rely on the inputs from sensors (cameras and optical LIDAR scanners) to complete path planning, drive real-time lane change path planning, and select safe and feasible lane driving, realizing planning of the driving path while driving. In addition, the present invention has high portability, can be freely expanded under the robot operating system, and can achieve real-time processing on embedded platforms.

To achieve the aforesaid objective, the present invention discloses a path planning system, which includes a sensing device and a processing device. The sensing device includes a camera and a light detection and ranging (LIDAR) scanner. The camera is configured to take a road image of a target road. The LIDAR scanner is configured to capture a plurality of distance data points of the target road and generate a road distance point cloud image. The processing device is electrically connected to the sensing device, and includes a camera LIDAR calibration module, a drivable area detection module, an adjacent lane information acquisition module, a main lane information acquisition module, a lane change path planning module, a lane maintaining path planning module and a path selection module. The camera LIDAR calibration module is configured to receive the road image from the camera, receive the road distance point cloud image from the LIDAR scanner, and project the road distance point cloud image onto the road image to generate a road and point cloud composite image. The drivable area detection module is configured to receive the road image from the camera, and generate a road segmentation image based on a deep learning model and a probabilistic graphical model. The adjacent lane information acquisition module is electrically connected to the camera LIDAR calibration module and the drivable area detection module, and is configured to receive the road and point cloud composite image and the road segmentation image, calculate an adjacent lane connected component for the road segmentation image to obtain an adjacent lane connected area, and generate an adjacent lane information point cloud of the adjacent lane connected area based on the road and point cloud composite image. The main lane information acquisition module is electrically connected to the camera LIDAR calibration module and the drivable area detection module, and is configured to receive the road and point cloud composite image and the road segmentation image, calculate an main lane connected component for the road segmentation image to obtain an main lane connected area, and generate an main lane information point cloud of the main lane connected area based on the road and point cloud composite image. The lane changing planning module is electrically connected to the adjacent lane information acquisition module and configured to receive the adjacent lane information point cloud, cluster the adjacent lane information point cloud based on a clustering algorithm, calculate an adjacent lane group center after clustering the adjacent lane information point cloud, convert a LIDAR coordinate of the adjacent lane group center into a vehicle coordinate, and smooth the vehicle coordinate to obtain a lane changing path point cloud. The lane maintaining planning module is electrically connected to the main lane information acquisition module and configured to receive the main lane information point cloud, cluster the main lane information point cloud based on the clustering algorithm, calculate a main lane group center after clustering the main lane information point cloud, convert a LIDAR coordinate of the main lane group center into a vehicle coordinate, and smooth the vehicle coordinate to obtain a lane maintaining path point cloud. The path selection module is electrically connected to the lane changing planning module and the lane maintaining planning module and configured to receive an obstacle information, the lane changing path point cloud and the lane maintaining path point cloud, and select one of the lane changing path point cloud lane maintaining path point cloud as a driving path according to the obstacle information.

The lane maintaining planning module obtains a primary path point cloud after converting the LIDAR coordinate of the main lane group center into the vehicle coordinate, inputs the primary path point cloud to a lane width filter, a front swing filter and a lane line filter to output a secondary path point cloud, and obtain the lane maintaining path point cloud according to the secondary path point cloud.

The lane maintaining planning module obtains the lane changing path point cloud by smoothing the secondary path point cloud through a Bézier curve.

The lane changing planning module obtains the lane changing path point cloud by converting the LIDAR coordinate of the adjacent lane group center to the vehicle coordinate, and smoothing the vehicle coordinate through a Bézier curve.

The clustering algorithm is a density-based spatial clustering of applications with noise (DBSCAN).

The path selection module receives the distance data points from the sensing module, and calculates a distance between the LIDAR scanner and each of the distance data points according to a time and a light speed, captured by the LIDAR scanner, of each of the distance data points, and obtains the obstacle information according to each of the distances.

The path selection module determines that at least one roadblock exists on the lane maintaining path point cloud according to the obstacle information, and selects the lane changing path point cloud as a driving path.

The path selection module determines that at least one roadblock exists on the lane changing path point cloud according to the obstacle information, and selects the lane maintaining path point cloud as a driving path.

The road segmentation image includes a main lane, at least one auxiliary lane, and a plurality of lane lines.

In addition, the present invention further discloses a path planning method for a path planning system. The path planning system is electrically connected to the sensing device and processing device. The sensing device is configured to capture a road image of a target road, capture a plurality of road image of the target road, and generate a road distance point cloud image. The path planning method is executed by the processing device, and comprises: receiving the road image and the road distance point cloud image, and projecting the road distance point cloud image onto the road image to generate a road and point cloud composite image; inputting the road image to a deep learning model and a probabilistic graphical model to generate a road segmentation image; calculating an adjacent lane connected component on the road segmentation image to obtain an adjacent lane connected area, and generating an adjacent lane information point cloud of the adjacent lane connected area based on the road and point cloud composite image; calculating an main lane connected component on the road segmentation image to obtain a main lane connected area, and generating a main lane information point cloud of the main lane connected area based on the road and point cloud composite image; clustering the adjacent lane information point cloud based on a clustering algorithm, and calculating an adjacent lane group center after clustering the adjacent lane information point cloud, converting a LIDAR coordinate of the adjacent lane group center into a vehicle coordinate, and smoothing the vehicle coordinate to obtain a lane changing path point cloud; clustering the main lane information point cloud based on a clustering algorithm, and calculating a main lane group center after clustering the main lane information point cloud, converting a LIDAR coordinate of the main lane group center into a vehicle coordinate, and smoothing the vehicle coordinate to obtain a lane maintaining path point cloud; and receiving an obstacle information, and selecting one of the lane changing path point cloud lane maintaining path point cloud as a driving path according to the obstacle information.

The path planning method further comprises: obtaining a primary path point cloud after converting the LIDAR coordinate of the main lane group center to the vehicle coordinate; inputting the primary path point cloud to a lane width filter, a front swing filter and a lane line filter to output the secondary path point cloud; and obtaining the lane maintaining path point cloud according to the secondary path point cloud.

The path planning method further comprises: obtaining the lane maintaining path point cloud by smoothing the secondary path point cloud through a Bézier curve.

The path planning method further comprises: obtaining the lane changing path point cloud by converting the LIDAR coordinate of the adjacent lane group center to the vehicle coordinate and smoothing the vehicle coordinate through a Bézier curve.

The clustering algorithm is a density-based spatial clustering of applications with noise (DBSCAN).

The path planning method further comprises: receiving the distance data points; calculating a distance between a LIDAR scanner and each of the distance data points according to a time and a light speed, captured by the LIDAR scanner, of each of the distance data points; and obtaining the obstacle information according to the distances.

The path planning method further comprises: determining that at least one roadblock exists on the lane maintaining path point cloud according to the obstacle information, and selecting the lane changing path point cloud as a driving path.

The path planning method further comprises: determining that at least one roadblock exists on the lane changing path point cloud according to the obstacle information, and selecting the lane maintaining path point cloud as a driving path.

The road segmentation image includes a main lane, at least one auxiliary lane, and a plurality of lane lines.

The detailed technology and preferred embodiments implemented for the present invention are described in the following paragraphs accompanying the appended drawings for people skilled in this field to well appreciate the features of the claimed invention.

### BRIEF DESCRIPTION OF THE DRAWINGS

FIG. 1 is a schematic view of the path planning system according to the present invention;

FIG. 2 is a road image taken by the camera of the present invention;

FIG. 3 is a road and point cloud composite image generated by the camera LIDAR calibration module of the present invention;

FIG. 4 is a road segmentation image generated by the drivable area detection module of the present invention;

FIG. 5 is a driving path generated by the path selection module of the present invention;

FIG. 6 is a flow chart of the path planning method according to the present invention;

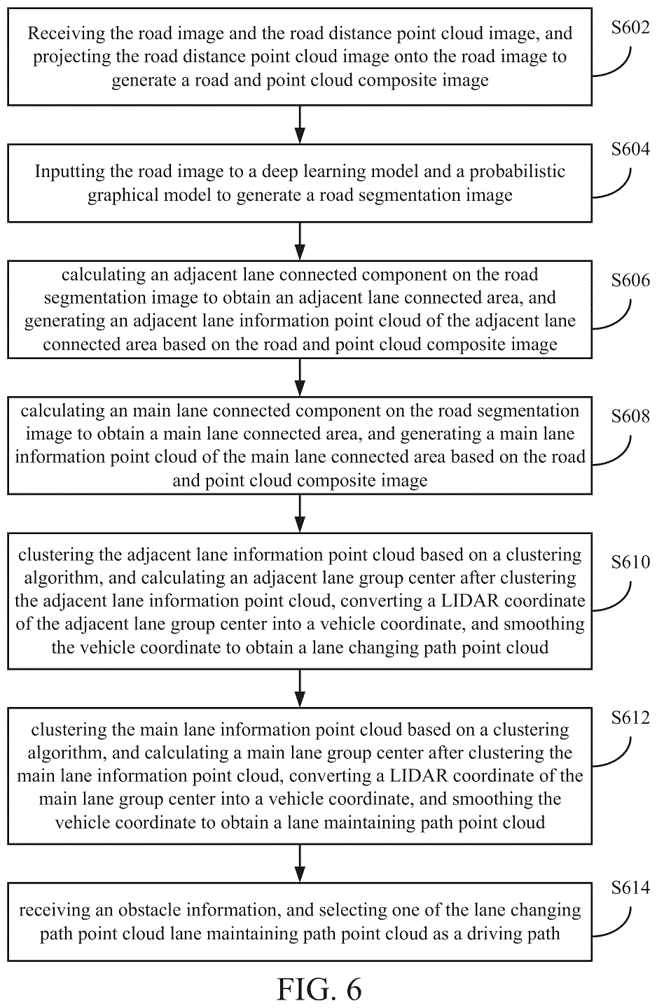

FIG. 7 is a flow chart of the path planning method according to the present invention; and

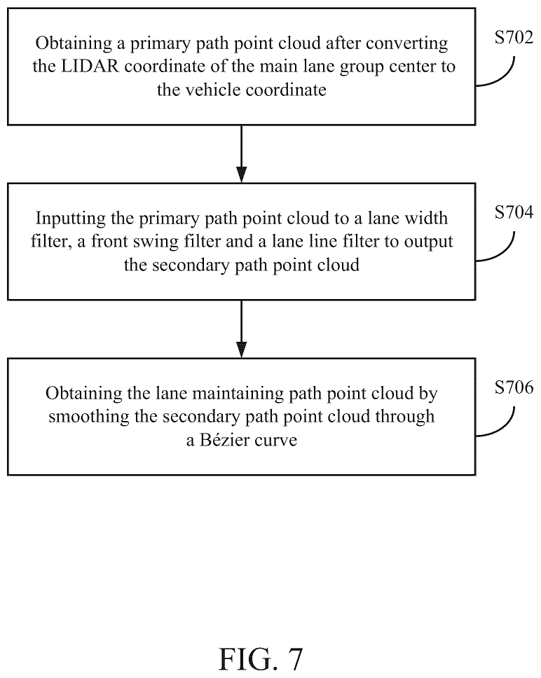

FIG. 8 is a flow chart of the path planning method according to the present invention.

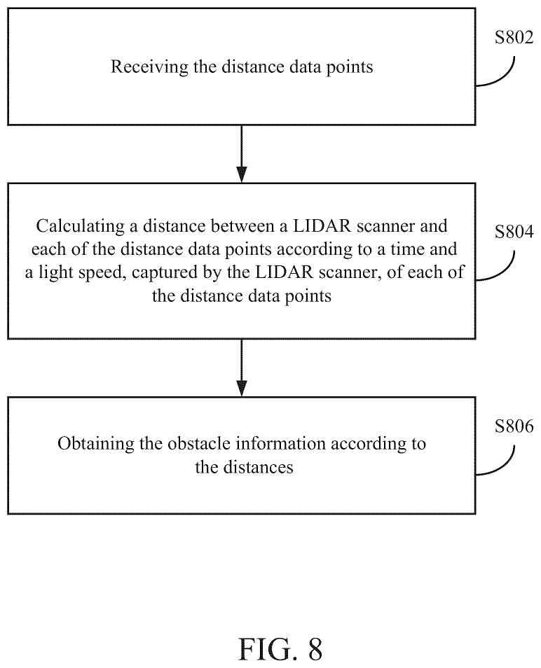

### DETAILED DESCRIPTION OF THE PREFERRED EMBODIMENT

Reference will now be made in detail to the present embodiments of the invention, examples of which are illustrated in the accompanying drawings, and are not intended to limit the present invention, applications or particular implementations described in these embodiments. Wherever possible, the same reference numbers are used in the drawings and the description to refer to the same or like parts. It shall be appreciated that, in the following embodiments and the attached drawings, elements unrelated to the present invention are omitted from depiction; and dimensional relationships among individual elements in the attached drawings are provided only for ease of understanding, but not to limit the actual scale.

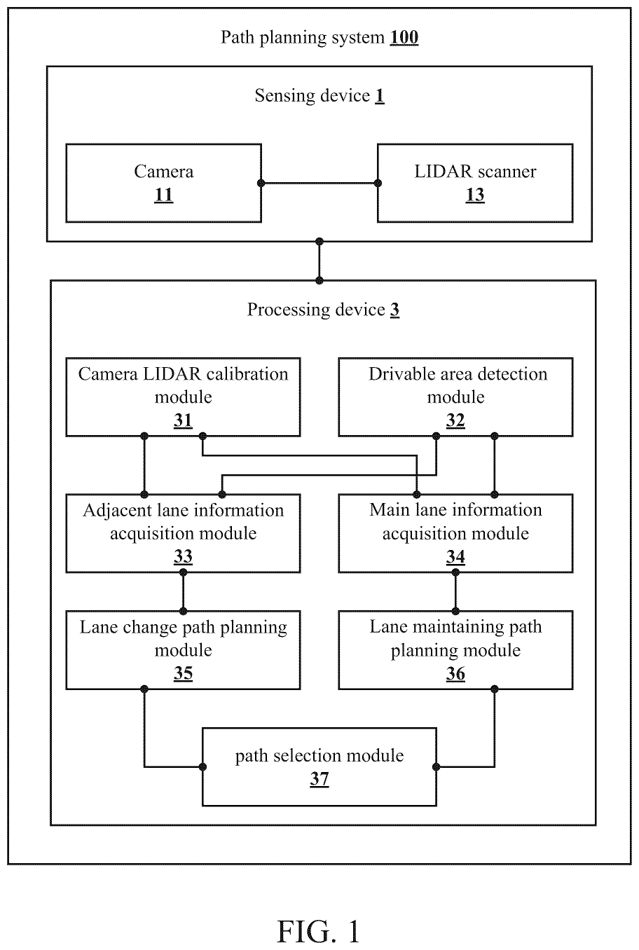

The first embodiment of the present invention is shown in FIG. 1 to FIG. 5. FIG. 1 is a schematic view of the path planning system according to the present invention. The path planning system 100 includes a sensing device 1 and a processing device 3. The sensing device 1 includes a camera 11 and a light detection and ranging (LIDAR) scanner 13. The camera 11 takes a road image P1 of a target road. The LIDAR scanner 13 captures a plurality of distance data points of the target road to generate a road distance point cloud image. The processing device 3 is electrically connected to the sensing device 1, and includes a camera LIDAR calibration module 31, a drivable area detection module 32, an adjacent lane information acquisition module 33, a main lane information acquisition module 34, a lane change path planning module 35, a lane maintaining path planning module 36 and a path selection module 37.

Specifically, the path planning system 100 of the present invention can be installed on a vehicle. The LIDAR scanner 13 can be used to create maps and driving trajectories for autonomous vehicles. While the vehicle is moving, the LIDAR scanner 13 emits laser beams in all directions. When these laser beams hit physical objects (such as pedestrians, other vehicles, barriers, sidewalks, buildings, etc.), they reflect back to the LIDAR scanner 13. The LIDAR scanner 13 treats each returning laser beam as a data point. Using the time each laser beam takes for returning and the speed of light, the LIDAR scanner 13 can calculate the distance between each data point and the LIDAR scanner 13 itself.

For example, when a pedestrian crosses the road and walks on the driving path of the vehicle, the multiple laser beams emitted by the LIDAR scanner 13 installed on the top of the vehicle will hit different parts of the pedestrian and bounce back. The LIDAR scanner 13 calculates the distance corresponding to each laser beam (that is, data point) according to the round-trip time of each laser beam and the speed of light, and generates a road distance point cloud map including the point cloud corresponding to pedestrians. In addition to the point cloud corresponding to the pedestrians, the road distance point cloud image also includes data points corresponding to surrounding objects such as vehicles, buildings, animals, plants, obstacles, and so on. These data points represent the distances between all physical objects surrounding the vehicle and the vehicle itself, as well as the depth of the space in which the vehicle is located.

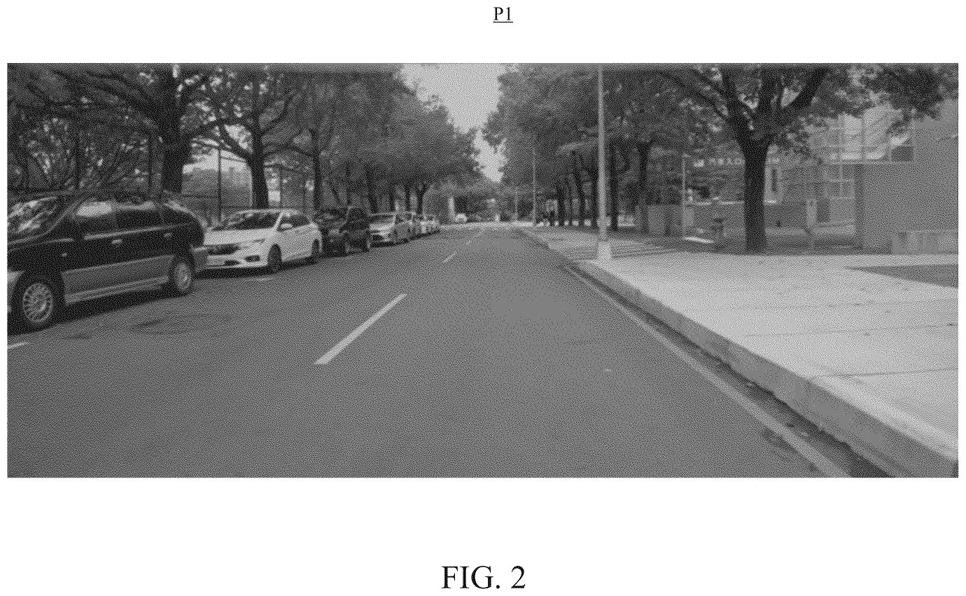

After generating the road distance point cloud image, the LIDAR scanner 13 sends the road distance point cloud image to the camera LIDAR calibration module 31 of the processing device 3. The camera 11 takes the road image P1, as shown in FIG. 2, and sends it to the camera LIDAR calibration module 31 and the drivable area detection module 32 at the same time.

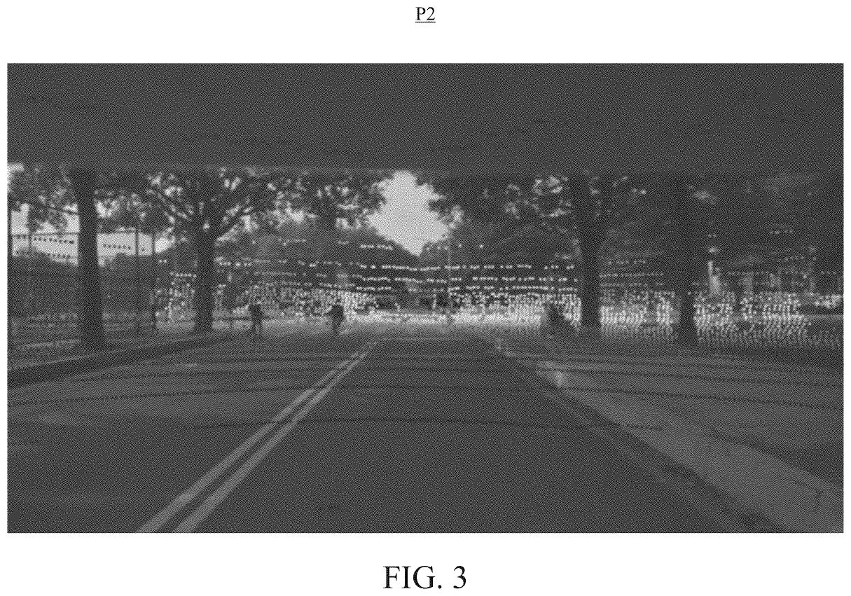

Please refer to FIG. 3, which depicts the road and point cloud composite image P2 generated by the camera LIDAR calibration module 31 of the present invention. The camera LIDAR calibration module 31 projects the road distance point cloud image to the road image P1 to generate the road and point cloud composite image P2. Since the camera coordinate of the camera 11 is different from the LIDAR coordinate of the LIDAR scanner 13, after the camera LIDAR calibration module 31 receives the road image P1 from the camera 11 and the road distance point cloud image from the LIDAR scanner 13, it needs to calculate an internal parameters of the camera 11 and the relative position of the LIDAR scanner 13 relative to the camera 11. The internal parameters of the camera 11 and the relative position of the LIDAR scanner 13 and the camera 11 only need to be calibrated once on the premise that the mechanism does not change.

During the projection stage, the camera LIDAR calibration module 31 can directly use the projection matrix to obtain the road and point cloud composite image P2. From the road and point cloud composite image P2, we can determine which pixels in the road image P1 correspond to each data point in the road distance point cloud image. By using the point cloud formed by these data points, we can determine the position of the physical objects.

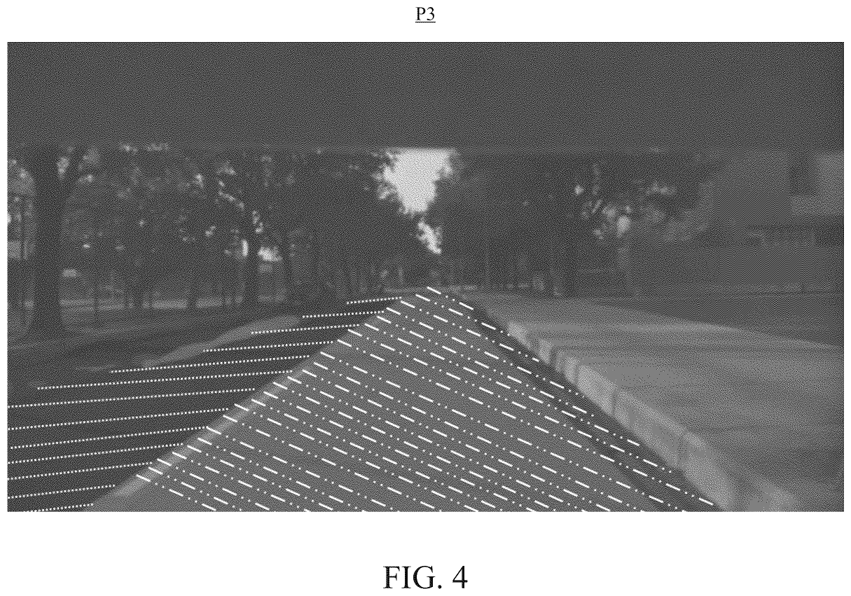

Reference is made to FIG. 4, which depicts the road segmentation image P3 generated by the drivable area detection module 32. The drivable area detection module 32 is configured to receive the road image P1 from the camera 11, and generate a road segmentation image P3 based on a deep learning model and a probabilistic graphical model. Specifically, the drivable area detection module 32 initializes the road image P1 by the deep learning model, loads the parameters of the deep learning model to construct a deep road segmentation network, generates a prediction map through inputting the road image P1 to the deep learning model, and input the prediction map to the probabilistic graph model, and generates the lane segmentation image and lane line segmentation image.

The lane segmentation image includes a road background, a main lane and an auxiliary lane. The lane line segmentation image includes various types of lane markings, such as single solid lines, double solid lines, and dashed lines. Next, the drivable area detection module 32 merges the lane segmentation image and the lane line segmentation image into the road segmentation image P3. In the present invention, the deep learning model is used to integrate the drivable area, lane lines and adjacent lane areas. The deep learning model also outputs detection results which saves computing resources and can be applied to embedded automotive systems.

The adjacent lane information acquisition module 32 is electrically connected to the camera LIDAR calibration module 31 and the drivable area detection module 32, and is configured to receive the road and point cloud composite image P2 and the road segmentation image P3, calculate an adjacent lane connected component for the road segmentation image P3 to obtain an adjacent lane connected area, and generate an adjacent lane information point cloud of the adjacent lane connected area based on the road and point cloud composite image P2.

To be more specific, the adjacent lane information acquisition module 33 first calculates the connected regions of adjacent lanes based on the road segmentation image P3. The adjacent lane information acquisition module 33 then inputs the road and point cloud composite image P2 to extract information about the adjacent lanes. This includes obtaining the pixels corresponding to all point clouds in the adjacent lanes, and then transforming these pixels from the camera coordinate system to the LIDAR coordinate system. After converting the adjacent lane information to point clouds, the adjacent lane information acquisition module 33 generates adjacent lane information point cloud.

The main lane information acquisition module 34 is electrically connected to the camera LIDAR calibration module 31 and the drivable area detection module 32, and is configured to receive the road and point cloud composite image P2 and the road segmentation image P3, calculate an main lane connected component of the road segmentation image P3 to obtain an main lane connected area, and generate an main lane information point cloud of the main lane connected area based on the road and point cloud composite image P2.

To be more specific, the main lane information acquisition module 34 first calculates the connected regions of adjacent lanes based on the road segmentation image P3. The main lane information acquisition module 34 then inputs the road and point cloud composite image P2 to extract information about the main lane. This includes obtaining the pixels corresponding to all point clouds in the main lane, and then transforming these pixels from the camera coordinate to the LIDAR coordinate. After converting the main lane information to point clouds, the main lane information acquisition module 34 generates main lane information point cloud.

The lane maintaining planning module 35 is electrically connected to the adjacent lane information acquisition module 33 and configured to receive the adjacent lane information point cloud, cluster the adjacent lane information point cloud based on the clustering algorithm, calculate an adjacent lane group center after clustering the adjacent lane information point cloud, convert a LIDAR coordinate of the adjacent lane group center into a vehicle coordinate, and smooth the vehicle coordinate through Bézier curve to obtain a lane changing path point cloud.

The lane changing planning module 35 inputs the adjacent lane information point cloud and the autonomous driving vehicle status. Only when the autonomous driving vehicle status is that the vehicle is not at the intersection can the lane changing be performed. The lane changing planning module 35 clusters the adjacent lane information point cloud using the density-based spatial clustering of applications with noise (DBSCAN) algorithm and calculates the adjacent lane group center. Then, the lane changing planning module 35 converts the LIDAR coordinate of the point clouds of the adjacent lane group center to the vehicle coordinate. After converting to the vehicle coordinate, the lane changing path point cloud is obtained by smoothing the vehicle coordinate through the Bézier curve.

The lane maintaining planning module 36 is electrically connected to the main lane information acquisition module 34 and configured to receive the main lane information point cloud, cluster the main lane information point cloud based on the clustering algorithm, calculate a main lane group center after clustering the main lane information point cloud, convert the LIDAR coordinate of the main lane group center into the vehicle coordinate to obtain the primary path point cloud. Then, the lane maintaining planning module 36 inputs the primary path point cloud to the lane width filter, the front swing filter and the lane line filter to output the secondary path point cloud, and obtains the lane maintaining path point cloud by smoothing the secondary path point cloud through Bézier curve.

The lane maintaining planning module 36 inputs the main lane information point cloud and the autonomous driving vehicle status, clusters the main lane information point cloud based on the DBSCAN, and calculates main lane group center. The lane maintaining planning module 36 converts the LIDAR coordinate of the point clouds of the main lane group center to the vehicle coordinate to obtain the primary path point cloud, preliminary filters the primary path point cloud, and inputs the filtered primary path point cloud to the lane width filter, the front swing filter and the lane line filter to ensure the quality of the path points. Then, the secondary path points are smoothed using Bézier curve to obtain the lane maintaining path point cloud.

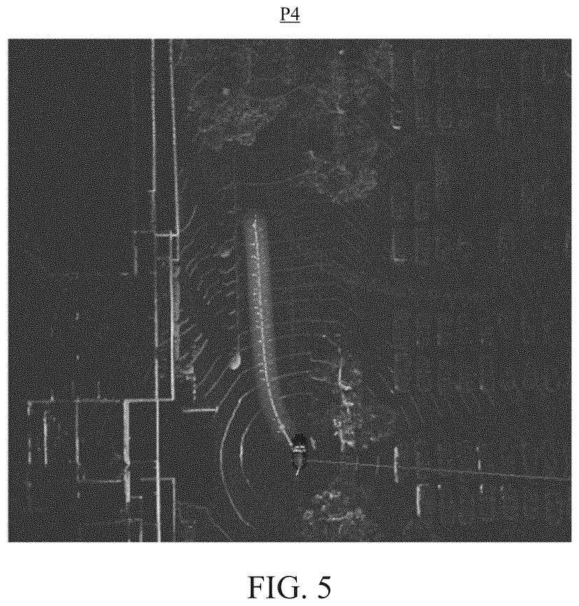

Reference is made to FIG. 5 which depicts the driving path P4 generated by the path selection module 37 of the present invention. The path selection module 37 is electrically connected to the lane changing planning module 35 and the lane maintaining planning module 36 and configured to receive an obstacle information, the lane changing path point cloud and the lane maintaining path point cloud, and select one of the lane changing path point cloud lane maintaining path point cloud as a driving path according to the obstacle information. The purpose of the path selection module 37 is to receive obstacle information, determine which of the lane maintaining path point cloud and lane changing path point cloud are unobstructed and can be smoothly traversed, and choose the safest path.

The path selection module 37 receives the distance data points from the sensing module 1, and calculates a distance between the LIDAR scanner 13 and each of the distance data points according to a time and a light speed, captured by the LIDAR scanner 13, of each of the distance data points, and obtains the obstacle information according to each of the distances.

When the path selection module 37 determines that at least one roadblock exists on the lane maintaining path point cloud according to the obstacle information, selects the lane changing path point cloud as a driving path. On the contrary, when the path selection module 37 determines that at least one roadblock exists on the lane changing path point cloud according to the obstacle information, selects the lane maintaining path point cloud as a driving path.

It shall be noted that the figures only shows one main lane and one auxiliary lane for illustration purposes. However, the path planning system and method of the present invention are also applicable to road systems with multiple auxiliary lanes. The number of main lanes and auxiliary lanes is not intended to limit the present invention. If there are multiple auxiliary lanes in the roadway, the path planning system and method of the present invention may include at least one auxiliary lane selection condition. When the path selection module determines that a lane change is necessary and at least two auxiliary lanes meet the lane change condition, the path selection module determines which auxiliary lane the vehicle will change to based on the auxiliary lane selection condition.

The second embodiment is a flow chart of the path planning method according to the present invention. The path planning method is applicable to a path planning system, for example, the path planning system 100 described in the above embodiment. The path planning system includes a sensing device and a processing device. The sensing device is configured to capture a road image of a target road, capture a plurality of road image of the target road, and generate a road distance point cloud image. The path planning method is executed by the processing device, the steps of the path planning method will be explained below.

First, in step S602, it relates to receiving the road image and the road distance point cloud image, and projecting the road distance point cloud image onto the road image to generate a road and point cloud composite image. In step S604, it relates to inputting the road image to a deep learning model and a probabilistic graphical model to generate a road segmentation image. The road segmentation image includes a main lane, at least one auxiliary lane, and a plurality of lane lines. In step S606, it relates to calculating an adjacent lane connected component on the road segmentation image to obtain an adjacent lane connected area, and generating an adjacent lane information point cloud of the adjacent lane connected area based on the road and point cloud composite image. In step S608, it relates to calculating a main lane connected component on the road segmentation image to obtain a main lane connected area, and generating a main lane information point cloud of the main lane connected area based on the road and point cloud composite image.

In step S610, it relates to clustering the adjacent lane information point cloud based on a clustering algorithm, calculating an adjacent lane group center after clustering the adjacent lane information point cloud, converting a LIDAR coordinate of the adjacent lane group center into a vehicle coordinate, and smoothing the vehicle coordinate to obtain a lane changing path point cloud. Further, by converting the LIDAR coordinate of the adjacent lane group center to the vehicle coordinate, and smoothing the vehicle coordinate through a Bézier curve, the lane changing path point cloud may be obtained.

In step S612, it relates to clustering the main lane information point cloud based on a clustering algorithm, calculating an main lane group center after clustering the main lane information point cloud, converting a LIDAR coordinate of the adjacent lane group center into a vehicle coordinate, and smoothing the vehicle coordinate to obtain a lane maintaining path point cloud. In step S614, it relates to receiving an obstacle information, and selecting one of the lane changing path point cloud lane maintaining path point cloud as a driving path according to the obstacle information.

In one embodiment, the clustering algorithm is a density-based spatial clustering of applications with noise (DBSCAN).

In step S612, it relates to obtaining the lane maintaining path point cloud further includes the following steps. In step S702, it relates to obtaining a primary path point cloud after converting the LIDAR coordinate of the main lane group center to the vehicle coordinate. In step S704, it relates to inputting the primary path point cloud to a lane width filter, a front swing filter and a lane line filter to output the secondary path point cloud. In step S706, it relates to obtaining the lane maintaining path point cloud according to the secondary path point cloud. In other embodiments, the path planning method further includes obtaining the lane maintaining path point cloud by smoothing the secondary path point cloud through a Bézier curve.

In addition, in step S614, in obtaining obstacle information, further includes the following steps. In step S802, it relates to receiving the distance data points. In step S804, it relates to calculating a distance between the LIDAR scanner and each of the distance data points according to a time and a light speed, captured by the LIDAR scanner, of each of the distance data points. In step S806, it relates to obtaining the obstacle information according to the distances.

In addition, in other embodiments, when at least one roadblock exists on the lane maintaining path point cloud according to the obstacle information, selects the lane changing path point cloud as a driving path. On the contrary, when at least one roadblock exists on the lane changing path point cloud according to the obstacle information, selects the lane maintaining path point cloud as the driving path.

In addition to above steps, the path planning method of the present invention can also be performed with all the steps and corresponding functions described in all the aforementioned embodiments. Those skilled in the art can understand how to perform such operations and have such functions based on all the aforementioned embodiments, it will not be further described.

According to the above descriptions, the path planning system and method of the present invention use deep learning network and probability map calculation to integrate road line segmentation and road line detection, which can greatly save the amount of computation, and can also achieve real-time processing. In addition, with the LIDAR point cloud, the depth information of multiple pixel positions can be extracted. These pieces of information are then processed through connected domain calculation and coordinate transformation to generate the lane change path planning image. The path planning system of the present invention can be applied to related industries such as automatic vehicle driving, automobile industry, industrial robot, unmanned vehicle or any driving assistance system.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A path planning system, comprising:
a sensing device, comprising:
a camera being configured to take a road image of a target road; and
a light detection and ranging (LIDAR) scanner being configured to capture a plurality of distance data points of the target road and generate a road distance point cloud image;
a processing device being electrically connected to the sensing device and comprising:
a camera LIDAR calibration module being configured to receive the road image from the camera, receive the road distance point cloud image from the LIDAR scanner, and project the road distance point cloud image onto the road image to generate a road and point cloud composite image;
a drivable area detection module being configured to receive the road image from the camera, and generate a road segmentation image based on a deep learning model and a probabilistic graphical model;
an adjacent lane information acquisition module being electrically connected to the camera LIDAR calibration module and the drivable area detection module, and being configured to receive the road and point cloud composite image and the road segmentation image, calculate an adjacent lane connected component for the road segmentation image to obtain an adjacent lane connected area, and generate an adjacent lane information point cloud of the adjacent lane connected area based on the road and point cloud composite image;
a main lane information acquisition module being electrically connected to the camera LIDAR calibration module and the drivable area detection module, and being configured to receive the road and point cloud composite image and the road segmentation image, calculate a main lane connected component for the road segmentation image to obtain a main lane connected area, and generate a main lane information point cloud of the main lane connected area based on the road and point cloud composite image;
a lane changing planning module being electrically connected to the adjacent lane information acquisition module and configured to receive the adjacent lane information point cloud, and cluster the adjacent lane information point cloud based on a clustering algorithm, and calculate an adjacent lane group center after clustering the adjacent lane information point cloud, and convert a LIDAR coordinate of the adjacent lane group center into a vehicle coordinate, and smooth the vehicle coordinate to obtain a lane changing path point cloud;
a lane maintaining planning module being electrically connected to the main lane information acquisition module and configured to receive the main lane information point cloud, and cluster the main lane information point cloud based on a clustering algorithm, and calculate a main lane group center after clustering the main lane information point cloud, and convert a LIDAR coordinate of the main lane group center into a vehicle coordinate, and smooth the vehicle coordinate to obtain a lane maintaining path point cloud; and
a path selection module being electrically connected to the lane changing planning module and the lane maintaining planning module and configured to receive an obstacle information, the lane changing path point cloud and the lane maintaining path point cloud, and select one of the lane changing path point cloud lane maintaining path point cloud as a driving path according to the obstacle information.

2. The path planning system as claimed in claim 1, wherein the lane maintaining planning module obtains a primary path point cloud after converting the LIDAR coordinate of the main lane group center into the vehicle coordinate, and inputs the primary path point cloud to a lane width filter, a front swing filter and a lane line filter to output a secondary path point cloud, and obtain the lane maintaining path point cloud according to the secondary path point cloud.

3. The path planning system as claimed in claim 2, wherein the lane maintaining planning module further obtains the lane maintaining path point cloud by smoothing the secondary path point cloud through a Bézier curve.

4. The path planning system as claimed in claim 1, wherein the lane changing planning module further obtains the lane changing path point cloud by smoothing the vehicle coordinate through a Bézier curve after convert the LIDAR coordinate of the adjacent lane group center to the vehicle coordinate.

5. The path planning system as claimed in claim 1, wherein the clustering algorithm is a density-based spatial clustering of applications with noise (DBSCAN).

6. The path planning system as claimed in claim 1, wherein the path selection module receives the distance data points from the sensing module, and calculates a distance between the LIDAR scanner and each of the distance data points according to a time and a light speed, captured by the LIDAR scanner, of each of the distance data points, and obtains the obstacle information according to each of the distances.

7. The path planning system as claimed in claim 1, wherein when the path selection module determines that at least one roadblock is existed on the lane maintaining path point cloud according to the obstacle information, the lane changing path point cloud is selected as the driving path.

8. The path planning system as claimed in claim 1, wherein when the path selection module determines that at least one roadblock is existed on the lane changing path point cloud according to the obstacle information, the lane maintaining path point cloud is selected as the driving path.

9. The path planning system as claimed in claim 1, wherein the road segmentation image includes a main lane, at least one auxiliary lane, and a plurality of lane lines.

10. A path planning method being used on a path planning system, the path planning system comprising a sensing device and a processing device, the sensing device being configured to take a road image of a target road, and capture a plurality of distance data points of the target road to generate a road distance point cloud image, the path planning method being executed by the processing device, and comprising:
receiving the road image and the road distance point cloud image, and projecting the road distance point cloud image onto the road image to generate a road and point cloud composite image;
inputting the road image to a deep learning model and a probabilistic graphical model to generate a road segmentation image;
calculating an adjacent lane connected component on the road segmentation image to obtain an adjacent lane connected area, and generating an adjacent lane information point cloud of the adjacent lane connected area based on the road and point cloud composite image;
calculating an main lane connected component on the road segmentation image to obtain a main lane connected area, and generating a main lane information point cloud of the main lane connected area based on the road and point cloud composite image;
clustering the adjacent lane information point cloud based on a clustering algorithm, and calculating an adjacent lane group center after clustering the adjacent lane information point cloud, converting a LIDAR coordinate of the adjacent lane group center into a vehicle coordinate, and smoothing the vehicle coordinate to obtain a lane changing path point cloud;
clustering the main lane information point cloud based on a clustering algorithm, and calculating a main lane group center after clustering the main lane information point cloud, converting a LIDAR coordinate of the main lane group center into a vehicle coordinate, and smoothing the vehicle coordinate to obtain a lane maintaining path point cloud; and
receiving an obstacle information, and selecting one of the lane changing path point cloud lane maintaining path point cloud as a driving path according to the obstacle information.

11. The path planning method as claimed in claim 10, further comprising:
obtaining a primary path point cloud after converting the LIDAR coordinate of the main lane group center to the vehicle coordinate;
inputting the primary path point cloud to a lane width filter, a front swing filter and a lane line filter to output the secondary path point cloud; and
obtaining the lane maintaining path point cloud according to the secondary path point cloud.

12. The path planning method as claimed in claim 11, further comprising:
obtaining the lane maintaining path point cloud by smoothing the secondary path point cloud through a Bézier curve.

13. The path planning method as claimed in claim 10, further comprising:
obtaining the lane changing path point cloud by converting the LIDAR coordinate of the adjacent lane group center to the vehicle coordinate and smoothing the vehicle coordinate through a Bézier curve.

14. The path planning method as claimed in claim 10, wherein the clustering algorithm is a density-based spatial clustering of applications with noise (DBSCAN).

15. The path planning method as claimed in claim 10, further comprising:
receiving the distance data points;
calculating a distance between a LIDAR scanner and each of the distance data points according to a time and a light speed, captured by the LIDAR scanner, of each of the distance data points; and
obtaining the obstacle information according to the distances.

16. The path planning method as claimed in claim 10, further comprising:
determining that at least one roadblock exists on the lane maintaining path point cloud according to the obstacle information, and selecting the lane changing path point cloud as a driving path.

17. The path planning method as claimed in claim 10, further comprising:
determining that at least one roadblock exists on the lane changing path point cloud according to the obstacle information, and selecting the lane maintaining path point cloud as a driving path.

18. The path planning method as claimed in claim 10, wherein the road segmentation image includes a main lane, at least one auxiliary lane, and a plurality of lane lines.
